(19) United States
(12) Patent Application Publication
(10) Pub. No.: US 2008/0289619 A1
(43) Pub. Date: Nov. 27, 2008

(54) Charbroiler

(75) Inventors: William S. Schjerven, SR., Schaumburg, IL (US); Theodore James Chmiola, Roscoe, IL (US); Frank J. Coleman, McHenry, IL (US); John H. Wiker, Lockport, IL (US); Frank Carbonara, Mount Juliet, TN (US); Gregory J. Tomko, Elgin, IL (US); Michael R. Matthews, JR., Crystal Lake, IL (US)

Correspondence Address: MICHAEL BEST & FRIEDRICH LLP, Two Prudential Plaza, 180 North Stetson Avenue, Suite 2000, CHICAGO, IL, 60601, US

(73) Assignee: MIDDLEBY CORPORATION, Elgin, IL (US)

(21) Appl. No.: 11/569,407

(22) PCT Filed: May 20, 2005
(86) PCT No.: PCT/US2005/017876

§ 371 Date: Nov. 12, 2007

Related U.S. Application Data
(63) Continuation-in-part of application No. PCT/US2004/005153, filed on Feb. 20, 2004.
(60) Provisional application No. 60/573,712, filed on May 21, 2004.
(60) Provisional application No. 60/449,545, filed on Feb. 21, 2003.

(51) Int. Cl. A47J 37/00; A47J 37/04; A47J 37/06

(52) U.S. Cl. 126/41 R; 126/41 C; 126/39 E; 99/386; 99/389

(57) ABSTRACT

Charbroilers, such as conveyorized and batch charbroilers, are disclosed wherein a single pilot flame receives gas from a gas line and is operable to ignite a plurality of burners. The charbroiler may include a housing, a conveyor removable from the housing and a shielding member removably connectable to the housing or burner and positioned between the burner and food product. The shielding member may be coated with a ceramic material and may have a color relating to a property of at least one of the shielding member and the ceramic material. In addition, the charbroiler may include a first burner and a second burner having different heating capacities. The charbroiler may also include an upper burner and lower burner positioned respectively above and below the food product and each of the upper and lower burners includes a ceramic diaphragm.

### RELATED APPLICATIONS

This application is a continuation-in-part of PCT Patent Application No. PCT/US2004/005153, filed Feb. 20, 2004, which claims the benefit of U.S. Provisional Patent Application No. 60/449,545, filed Feb. 21, 2003, and this application also claims the benefit of U.S. Provisional Patent Application No. 60/573,712, filed May 21, 2004, all of which are incorporated herein by reference.

### BACKGROUND OF THE INVENTION

This invention relates generally to gas charbroilers and, more particularly, to high reliability, low-maintenance conveyorized and batch gas charbroilers.

The grilling of meats like hamburgers, steaks, chicken and the like (hereinafter referred to as “food product”) is favored by many people because of the flavoring and other organoleptic properties imparted to the food product by the grilling process and because broiling releases fats and hence reduces the caloric content of the food product. As a result, for example, restaurants often provide many such grilled products on their menus.

Various types of charbroilers have been developed for use in environments like restaurants where large quantities of grilled food product need to be prepared continuously and quickly. Some of the charbroilers developed include large batch charbroilers and conveyorized charbroilers. Batch charbroilers have a heating cavity with a single opening in which to insert and remove food product. Accordingly, the heating cavity is a relatively confined space with little air flow. Conveyorized charbroilers include a heating tunnel having openings at both ends and a conveyor traveling through the tunnel to transport food through the tunnel. Conveyorized charbroilers often have better air flow therethrough than batch broilers. Unfortunately, many of the available charbroilers are not reliable in their operation. For example, some of these charbroilers have difficulties lighting and maintaining flame in their heating elements. Other charbroilers require frequent cleaning of the heating elements due to the buildup of fat and other components of the food product that drip onto the heating elements, conveyors, or other charbroiler surfaces as the charbroiler operates. Also, adjustment of the flame in the heating elements is often difficult if not impossible in available charbroilers.

Flare-up is another problem that exists in many of the conventional charbroilers. Flare-up often occurs when the fat or other components of the food product drips or falls from the food product and contacts the heating elements. Accordingly, flare-up primarily occurs in those charbroilers with heating elements below the food product. In order to avoid flare-up, batch charbroilers do not use heating elements located below the food product. Due to the lack of food product movement relative to the heating elements and the limited air movement through a batch charbroiler, flare-up would occur often and easily in a batch charbroiler if the heating elements were placed below the food product. Some conveyorized charbroilers however do have heating elements located below the food product, and flare-up is a problem in such conveyorized charbroilers. The dripped fat or other food components falls on the heating elements and instantly bursts into flame (flare-up), which causes the cooking temperature within the charbroiler to fluctuate from the desired cooking temperature. Food product can be burned or otherwise over cooked (i.e., rather than cooking a steak to a desired medium level, the steak is cooked well-done) if flare-up occurs in the charbroiler.

Heating element inefficiency is another problem that occurs in conventional charbroilers. Inefficiency occurs when heating elements are disposed both above and below the food product and the by-products from the lower heating elements rise and interfere with the upper heating elements. The by-products displace much needed oxygen around the upper heating elements which can cause the heating output of the upper heating elements to fluctuate, thereby decreasing the efficiency of the upper heating elements. Batch charbroilers do not include lower heating elements in order to decrease the chance of this type of inefficiency. However, in conveyorized charbroilers that use both upper and lower heating elements, the by-products of the lower heating elements often interfere with the efficient burning of the upper heating elements.

The present invention is intended to solve the problems outlined above by providing a charbroiler in which the heating elements can be easily lit, the cooking flames are reliably and efficiently maintained, clogging of the heating elements is minimized and adjustment of heat levels is readily achieved. These and other objects and advantages of the present invention will become apparent from the description, drawings and claims which follow below.

### SUMMARY OF THE INVENTION

In some aspects, a charbroiler is provided and includes a housing, a plurality of burners positioned within the housing for heating food product positioned within the housing, a gas line coupled to the plurality of burners for providing gas to the burners, and a single pilot flame receiving gas from the gas line and being operable to ignite the plurality of burners.

In other aspects, a conveyorized charbroiler is provided and includes a housing defining a heated tunnel therethrough, a conveyor at least partially positioned within the housing to move food product through the tunnel, wherein the conveyor is removable from the housing, and a burner positioned within the housing for heating food product moving through the tunnel.

In yet other aspects, a conveyorized charbroiler is provided and includes a housing defining a heated tunnel therethrough, a conveyor at least partially positioned within the housing to move food product through the tunnel, a burner positioned within the housing for heating food product positioned within the tunnel, and a shielding member connected to one of the housing and the burner in a position between the burner and food product, the shielding member being at least partially made of glass.

In further aspects, a batch charbroiler is provided and includes a housing defining a food cavity therein with an opening through which food is insertable into and removable from the food cavity, a burner positioned within the housing for heating food product positioned within the food cavity, and a shielding member connected to one of the housing and the burner in a position between the food product and the burner, the shielding member being at least partially made of glass.

In some aspects, a charbroiler is provided and includes a housing defining a cavity with an opening through which food product is insertable into the cavity, a burner positioned within the housing for heating food product positioned within the cavity, and a shielding member connected to one of the housing and the burner in a position between the food product and the burner, the shielding member being at least partially coated with a ceramic material.

In other aspects, a conveyorized charbroiler is provided and includes a housing defining a heated tunnel therethrough, a conveyor at least partially positioned within the housing to move food product through the tunnel, and a burner positioned within the housing for heating food product moving through the tunnel, the burner including a ceramic diaphragm capable of emitting heat.

In yet other aspects, a charbroiler for cooking food product is provided and includes a housing, an upper burner connected to the housing and positioned above the food product for heating the food product, the upper burner including a ceramic diaphragm capable of emitting heat, and a lower burner connected to the housing and positioned below the food product for heating the food product, the lower burner including a ceramic diaphragm capable of emitting heat.

In further aspects, a charbroiler for cooking food product is provided and includes a housing in which food product is positionable for cooking, a first burner supported by the housing for cooking food product, and a second burner supported by the housing for cooking food product, wherein the first burner and the second burner have different heating capacities.

In some aspects, a charbroiler is provided and includes a housing in which food product is positionable for cooking, a burner connected to the housing for cooking the food product in the housing, and a shielding member connected to one or both of the housing and the burner in a position between the food product and the burner, the shielding member being at least partially coated with a material having a color relating to a property of at least one of the material and the shielding member.

### BRIEF DESCRIPTION OF THE DRAWINGS

FIG. 1 is a perspective view of a charbroiler in accordance with a first embodiment of the present invention, shown with a top cover removed;

FIG. 2 is a perspective view of upper and lower banks of burners used in the charbroiler of FIG. 1;

FIGS. 3A, 3B, 3C and 3D are views of a representative burner used in the charbroiler of FIG. 1;

FIGS. 4A, 4B, 4C and 4D are views of a screen applied to the burner of FIGS. 3A, 3B, 3C and 3D;

FIG. 5 is a top view of the charbroiler of FIG. 1;

FIGS. 6A and 6B are views of pilot assemblies of the charbroiler of FIG. 1;

FIGS. 7A, 7B, 7C and 7D are views of an alternative embodiment of a pilot shield of a pilot assembly used in the charbroiler of FIG. 1;

FIG. 8 is an enlarged view of an ignition assembly of the pilot assembly of FIGS. 6A and 6B;

FIGS. 9A, 9B and 9C are views of the burners of the charbroiler of FIG. 1 as mounted within the charbroiler;

FIG. 10 is a perspective view of a charbroiler in accordance with a second embodiment of the present invention;

FIG. 11 is a perspective view of a portion of the charbroiler of FIG. 10, showing drip trays of the charbroiler;

FIG. 12 is a side view of a portion of the charbroiler of FIG. 10, showing drip trays of the charbroiler;

FIG. 13 is a perspective view of a portion of the charbroiler of FIG. 10, showing a removable conveyor and a quick-disconnect conveyor structure;

FIG. 14 is a left perspective view of a portion of the charbroiler of FIG. 10, showing motors, chains and sprockets of the charbroiler;

FIG. 15 is a right perspective view of the portion of the charbroiler of FIG. 14;

FIG. 16 is a top perspective view of a conveyor of the charbroiler of FIG. 10, shown in an unfolded condition;

FIG. 17 is an enlarged top perspective view of a portion of the conveyor of FIG. 16;

FIG. 18 is a top perspective view of the conveyor of FIG. 16, shown in a folded condition;

FIG. 18A is an enlarged perspective view of a portion of the conveyor of FIG. 16;

FIG. 19 is a perspective view of a plurality of burners and a pilot assembly of the charbroiler of FIG. 10;

FIG. 20 is a top view of the burners and pilot assembly shown in FIG. 19;

FIG. 21 is a side view of the burners and pilot assemblies shown in FIG. 19;

FIG. 22 is an end view of the burners and pilot assemblies shown in FIG. 19;

FIGS. 23A-23D are views of a burner and a plate of the charbroiler shown in FIG. 10;

FIG. 24 is a perspective view of a plate of the charbroiler shown in FIG. 10, shown with various coatings;

FIG. 25 is a perspective view of a plate and a portion of the charbroiler shown in FIG. 10;

FIG. 26 is a side view of an alternative embodiment of plates of the charbroiler shown in FIG. 10, shown in an angled orientation;

FIG. 27 is a perspective view of a batch charbroiler in accordance with a third embodiment of the invention; and

FIG. 28 is a side view of the batch charbroiler of FIG. 27, shown with a side of the charbroiler removed.

### DETAILED DESCRIPTION

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. For instance, the description and figures describe and show a conveyorized charbroiler, however, many of the features described and shown are applicable to batch charbroilers as well. Accordingly, the features illustrated in the drawings and described below are capable of being employed in batch charbroilers unless otherwise stated.

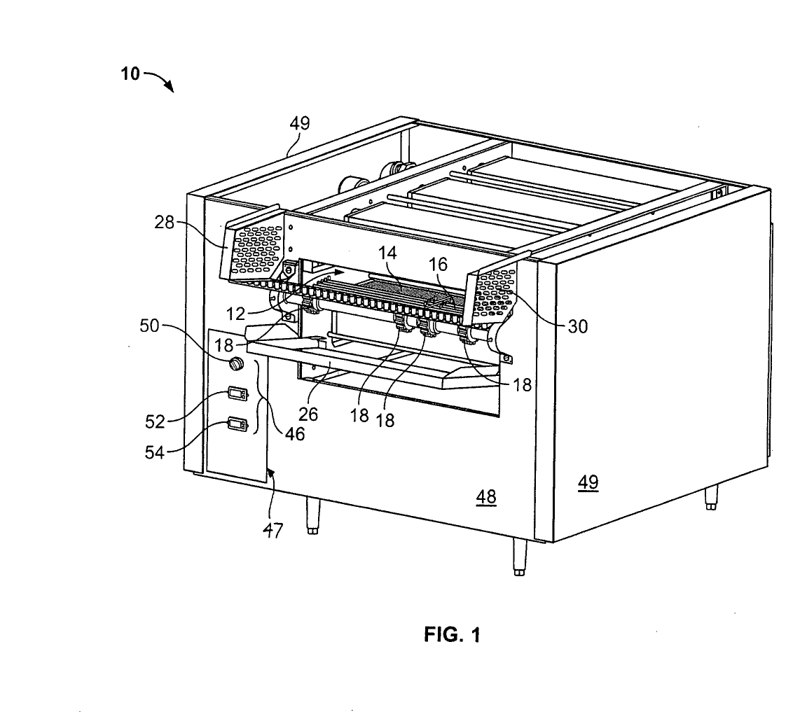

FIG. 1 is a perspective view of a conveyorized charbroiler 10 having upper and lower heating elements or burners and conveyors for transporting food through the charbroiler 10 between the upper and lower burners, as will be described below. In this figure, an inlet opening 12 can be seen in which two conveyor belts 14 and 16 are shown, with conveyor 14 being wider than conveyor 16 in this particular embodiment. Although two conveyors are illustrated, it should be understood that the charbroiler 10 can include any number of conveyors. These conveyors extend out of opening 12, to enable meat or other food to be placed onto them before the conveyor moves the food into and through the charbroiler 10. The conveyors, which are disposed between the upper and lower burners, are of an open metal grid design to permit heat from the lower burners to reach the bottom of food supported on the conveyors and to permit juices, fats and other food components to drip through the conveyors during the cooking process, which is essential to properly prepare the food and produce the desired properties in the final broiled product. One type of conveyor that could be used is a Sani-Grid® belt available from Cambridge Belt of Cambridge, Mass.

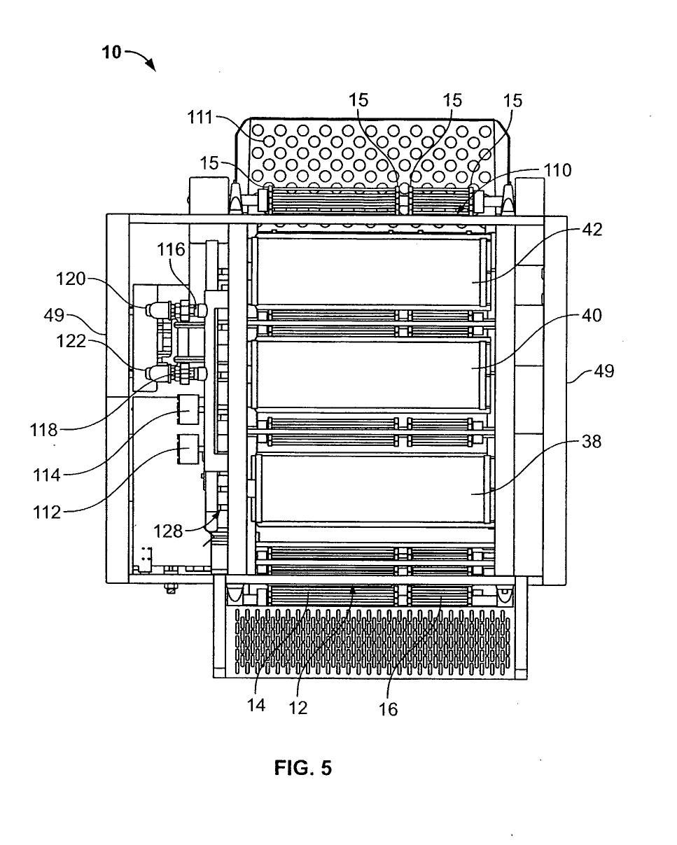

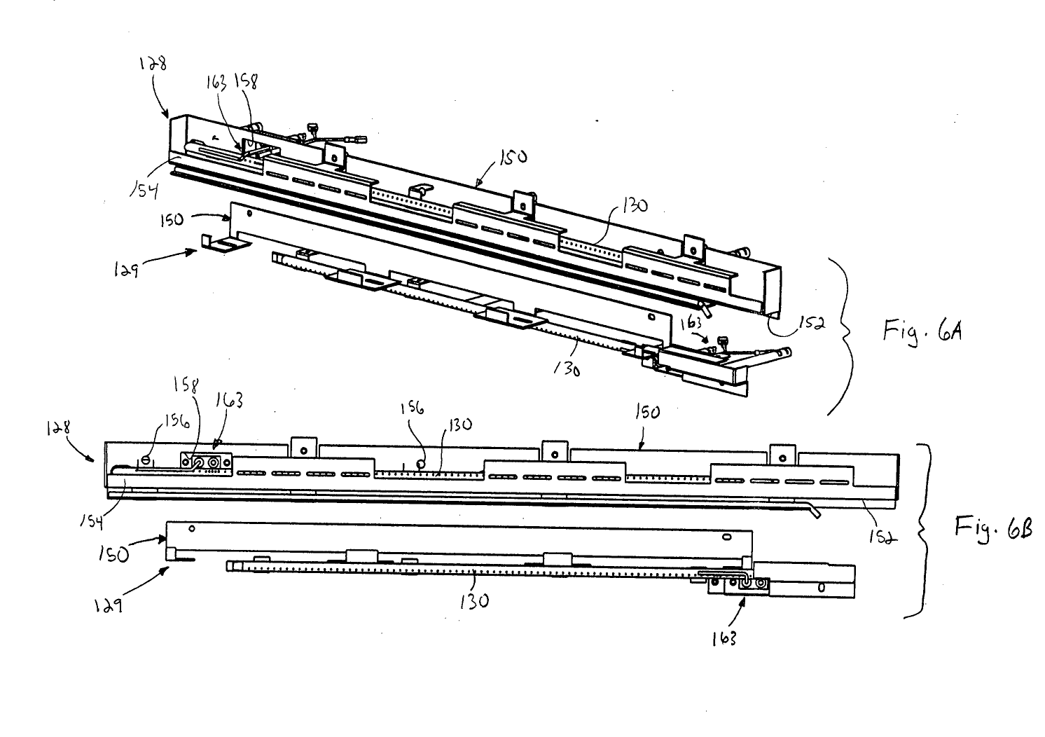

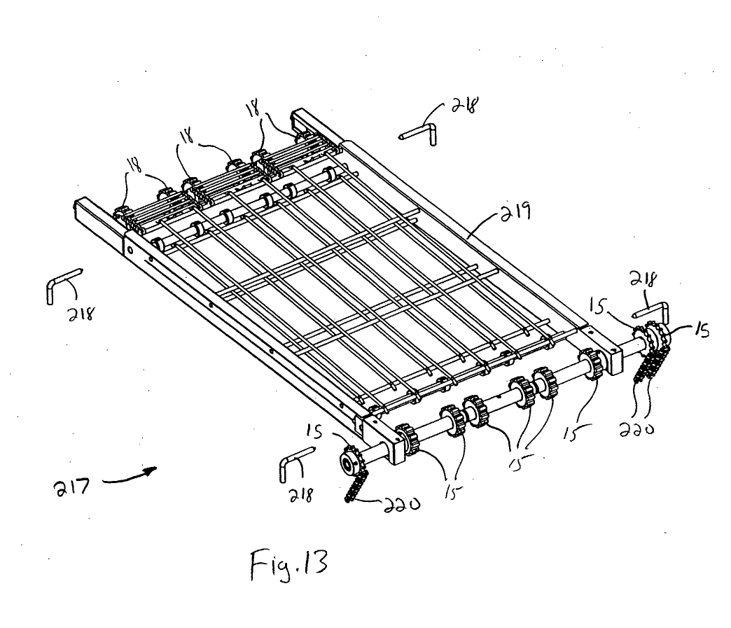

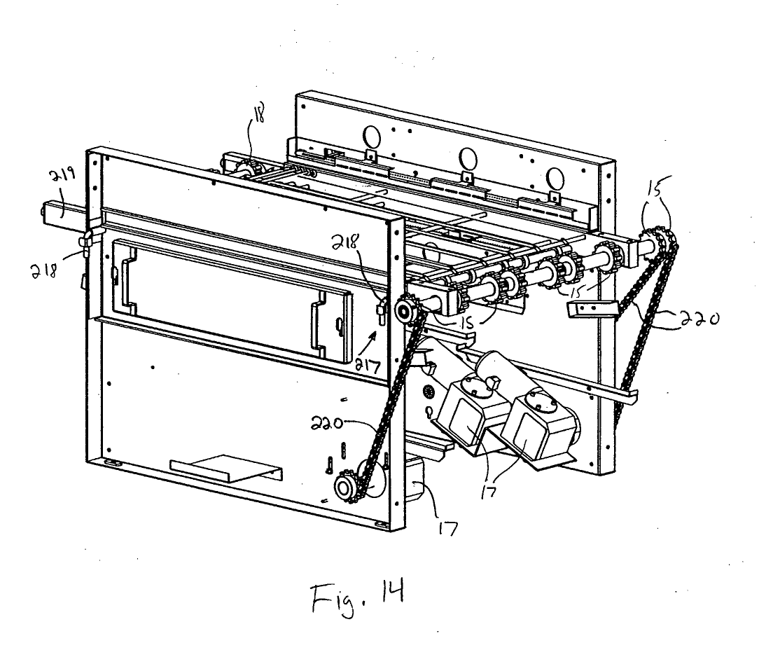

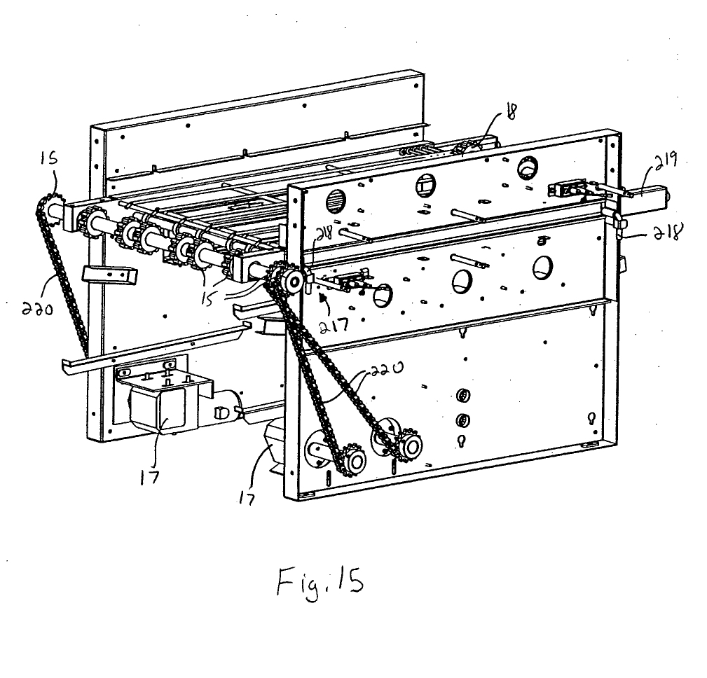

Conveyors 14 and 16 are driven by drive sprockets 15 (see FIGS. 5 and 13), which are driven by motors 17. The conveyors 14 and 16 wrap around and are guided by idler sprockets 18. These drive and idler sprockets 15, 18 prevent slippage of the belts, particularly when loaded with food. The conveyors 14, 16 are positioned in a plane slightly closer to the bottom burners than the top burners, since some of the heating produced by the bottom burners is attenuated by the conveyors and must be compensated for by positioning the food on the belt closer to the bottom burners. As can also be seen in this view, a tray 26 is positioned below the inlet of the charbroiler 10 to catch any debris that might fall off as the food is put onto the conveyors 14, 16. Guards 28 and 30, which may be wire form rather than punched metal as shown, are also provided to both prevent the food from sliding off of the conveyors 14, 16 and to move any food that is positioned beyond an edge of the conveyors back onto the conveyors before it enters the charbroiler 10.

Controls 46 for the charbroiler are shown on a front 48 of the charbroiler 10 and, more particularly, are located on a control panel 47. The controls 46 include an on/off switch 50 and speed controls/display(s) 52 and 54 for controlling the speed of conveyors 14 and 16. The front 48 and sides 49 of the charbroiler 10 are generally flat and are removable without the use of tools to facilitate quick and easy cleaning.

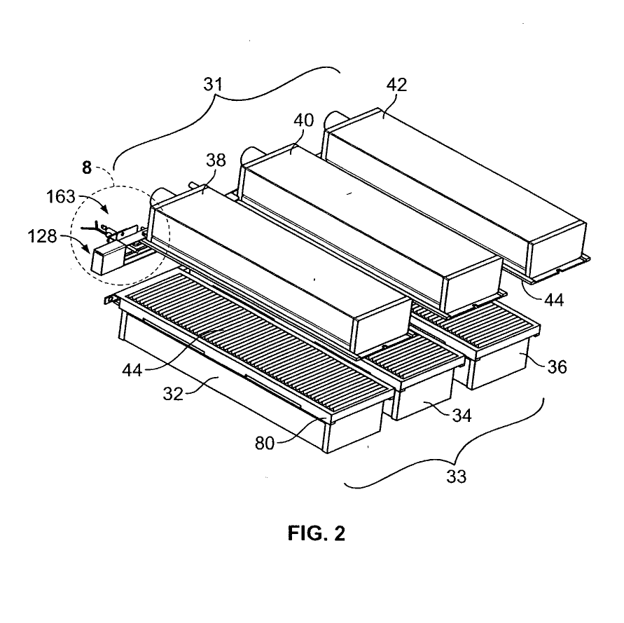

FIG. 2 is a perspective view of upper and lower banks of burners, 31 and 33 respectively, of the charbroiler 10. In the illustrated embodiment, three lower burners, 32, 34 and 36 and three upper burners 38, 40 and 42 are used, although any number of lower and upper burners may be used. In the illustrated construction, the lower and upper burners are substantially the same size and have substantially the same heating capacity. Alternatively, the charbroiler 10 can include burners having varying sizes and heating capacities relative to each other. For example, the lower burners 32, 34, 36 can have different heating capacities from the upper burners 38, 40, 42, or the individual burners within the series of the upper burners or the lower burners can have different heating capacities relative to each other. Bottom burners 32, 34, and 36 are arranged generally in a plane with their heating surfaces 44 oriented upwardly. Upper burners 38, 40, and 42 are arranged generally parallel to bottom burners 32, 34, and 36, with their heating surfaces 44 oriented downwardly.

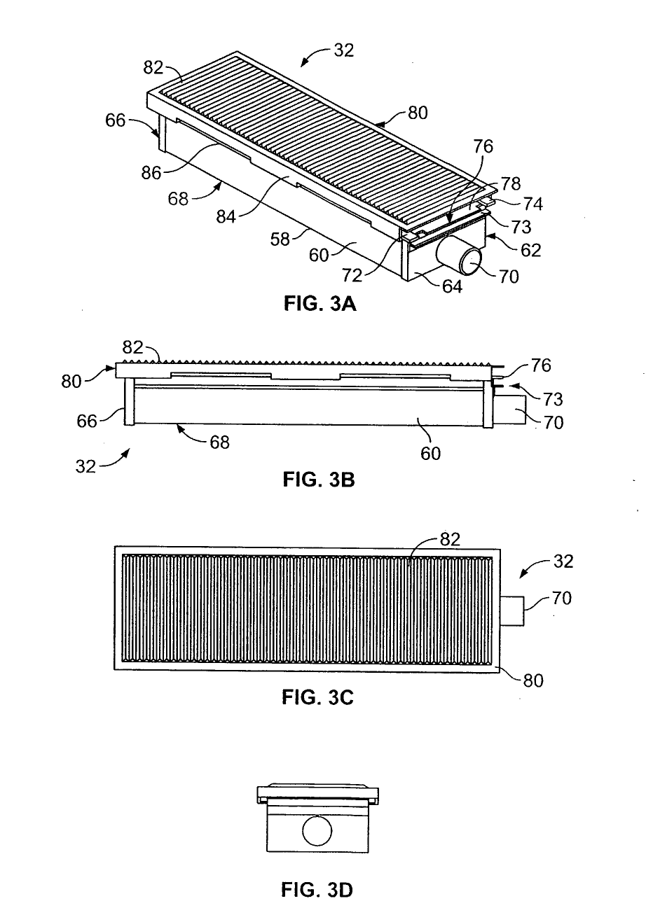

FIGS. 3A, 3B, 3C, and 3D are perspective, side elevation, plan and end elevation views, respectively, of a representative one (32) of the lower bank of burners 33 used in the charbroiler 10. Burner 32 includes a generally rectangular burner housing 58 having opposite elongated sides 60 and 62, opposite ends 64 and 66, and a bottom 68. The burner housing 58 can be made of a variety of appropriate materials including, for example, stainless steel and aluminized steel. A tubular gas inlet 70 passes through end 64 of the burner assembly. Additionally, lips 72 and 74 project outwardly from the top edges of sides 60 and 62 of the burner housing.

A generally horizontally disposed surface combustion burner 76 is supported in the burner housing with it top surface 78 generally adjacent the top edge of the burner housing 58. In the illustrated embodiment, the surface combustion burner 76 comprises a gas permeable sintered ceramic burner diaphragm (not shown). Typical of such burners are infrared ceramic burner diaphragms available from Global Cabling Systems of California, Solaronics, Inc. of Michigan and Infrared Dynamics, Inc. of Michigan. Among these, the Global Cabling Systems ceramic burner diaphragms are presently preferred.

When a mixture of air and flammable gas such as natural gas or propane is supplied to the interior of the burner housing 58 adjacent the bottom of the burner and the gas is ignited, the mixture burns on the opposite (top) side of the diaphragm heating the ceramic surface of the diaphragm to a red-hot condition and causing it to discharge radiant infrared heat. Once the red-hot condition is reached, the flames may pull back to just below the ceramic surface. Such sintered ceramic burners are preferred because they are sturdy and provide a large heated surface area, low pressure loss and good combustion efficiency.

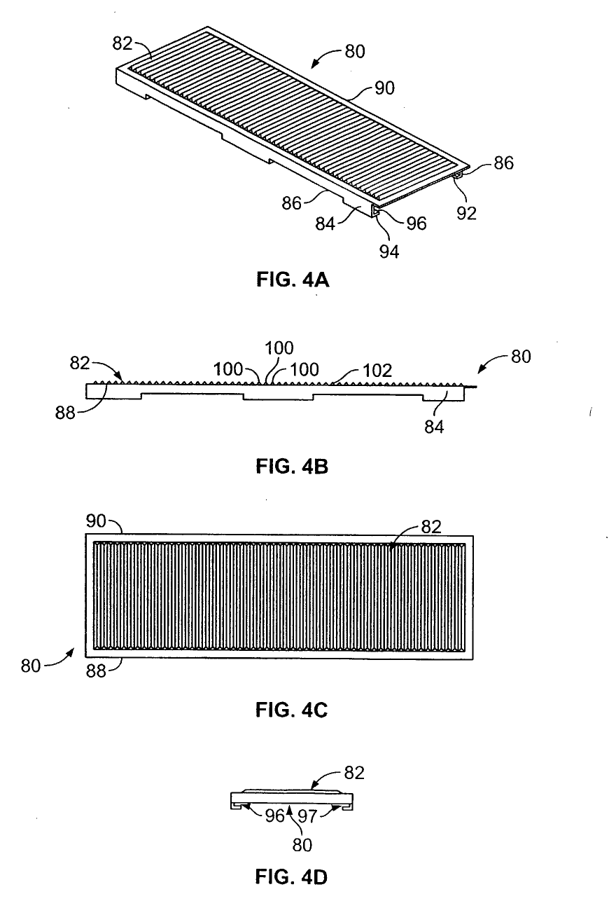

Removable shielding members or screens 80 are fitted to at least the lower burners 33 in the charbroiler 10, and may be fitted to the upper burners 31 as well. These screens 80 are best understood from FIGS. 4A, 4B, 4C and 4D, which are perspective, elevation side, top and elevation end views, respectively, of a representative screen 80. Screen 80 includes a top surface 82 and downwardly directed generally perpendicular flanges 84 and 86 along the elongated edges 88 and 90 of the screen 80. Inwardly directed generally perpendicular lips 92 and 94 are formed on the flanges 84, 86 which define channels 96 and 97, respectively, between lips 92 and 94 and the screen top surface 82 along edges 88 and 90 of the screen 80. Screens 80 may thus be slid on and off of the burner housings by aligning the lower channels 96 and 97 with housing lips 72 and 74 and sliding the screens 80 into place on the burner housing 58. Removal for cleaning or replacement can easily accomplished by sliding the screens 80 off of the burner housings 58. When the screens 80 are slid onto the burner housings 58, the top of the screens 80 and the top of the ceramic burner are spaced apart preferably about 0.25-0.75 inches (about 6.35-19.05 millimeters) and more preferably about 0.5 inches (about 12.7 millimeters).

In some constructions, the screen 80 is metallic and made of an alloy that can withstand the high temperatures produced by the closely proximate ceramic burners. A series of ribs 100 are formed in the screen to, among other things, enhance the rigidity of the screen 80. These ribs 100 may be formed by pressing the screens between dies of the appropriate configuration or by another method if desired. In the illustrated embodiment, screen 80 is about 7 by 21.625 inches to correspond to the dimensions of the top of burner housing 58. (These dimensions are, of course, only representative and not intended to limit the invention.) In this case, ribs 100 are formed each about 0.08 to 0.2 inches in height and preferably about 0.125 inches in width. The point-to-point spacing of the ribs at their uppermost edge should be about 0.25 to 0.5 inches and preferably 0.375 inches. The sides 102 of the ribs 100 which are at an angle to the horizontal cause grease that drips onto the screens to run down the rib sides at an angle, delaying the time it takes for the grease to reach the surface of the ceramic burners. This delay permits much of the grease to be burned off before it reaches the burner surface, minimizing clogging of the burner and other difficulties associated with burning grease that drops onto the sintered ceramic surface. The ribs 100 are configured to provide a certain amount of openness to the screen 80. The screen 80 should be about 30-70% open and more preferably about 50% open. The details and parameters listed herein relating to the screens 80 are examples only and are not meant to be limiting. Accordingly, the screens 80 can have a variety of different details and parameters than those listed herein and still be within the spirit and scope of the present invention.

Screen 80 has other unexpected salutary effects. It enhances the infrared effect produced by the burners by improving the uniformity of the distribution of the infrared heat. It also helps to disperse the by-products or combustibles emerging from the lower burner which have the potential to interfere with the operation of the upper burners by reducing the oxygen available for combustion. Among other things, this permits the upper burners to run more efficiently and to be positioned more closely together, producing greater heating and accelerated broiling.

We turn now to FIG. 5, which is a top view of the charbroiler 10 shown with a cover or shield 104 (shown in FIG. 10) removed. While no cover 104 is present in FIG. 5, reference is made to FIG. 10 in which the shield 104 is illustrated. The shield 104 is sufficiently sized to support a catalytic converter (not shown), which is required in some states, and is operable to prevent flames from coming over the top of the charbroiler 10 and to prevent ignition of the main gas opening.

In FIG. 5, the tops of the housings of the three top burners 38, 40, and 42 mounted in the charbroiler 10 are visible. Likewise, the wide and narrow conveyors 14 and 16 are shown extending from the inlet opening 12 to the outlet opening 110 of the charbroiler 10. Additionally, pressure gauges 112 and 114 measure the gas pressure of the gas supplied through gas lines 116 and 118 that feed into the manifold common to the upper bank of burners 31 and to the manifold common to the lower bank of burners 33 to supply the gas to the upper and lower burners. Additionally, valves 120 and 122 are positioned in the gas lines 116 and 118 to permit the adjustment of the pressure of the gas supplying the upper and lower burner housings, thereby permitting the groups of upper and lower burners to be adjusted independently of each other. In the illustrated embodiment this pressure will be varied in the range of about 3-5 inches water column. Finally, an upper pilot flame distributor or pilot flame runner tube 130 (see FIGS. 6A and 6B) of an upper pilot assembly 128 (see FIGS. 6A and 6B) is shown in communication with upper burners 38, 40 and 42. A like lower pilot assembly 129 (see FIGS. 6A and 6B) is configured and positioned in the same way below the upper pilot assembly 128 and is in communication with bottom burners 32, 34 and 36.

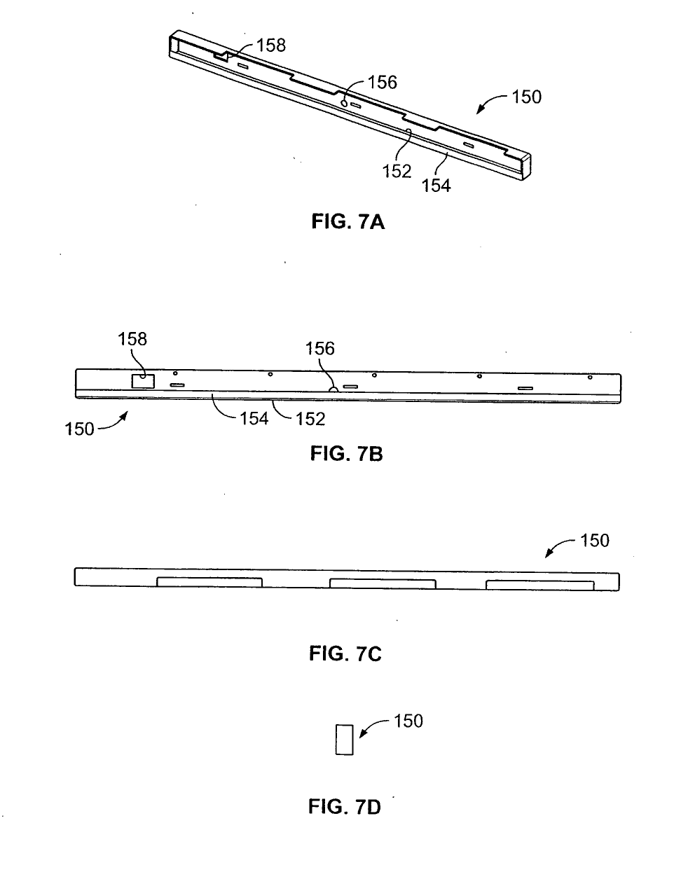

With reference to FIGS. 6A and 6B, the pilot assemblies 128, 129 are mounted behind sides 49 of the charbroiler 10. Each pilot assembly includes a pilot tube 130, an air shield or pilot shield 150 and an electronic ignition assembly 163. The pilot tubes 130 are in communication with the gas line to receive gas therefrom and include a plurality of holes therein for releasing gas and allowing a flame to propagate down the pilot tubes 130 in a manner known in the art. The pilot tubes 130 are positioned substantially within the shield 150, which will be described hereinafter. Additional reference is made to FIGS. 7A-7D, which show an alternative construction of the shields 150. Like components are identified with like reference numbers. The shields 150 inhibit air from flowing down the pilot tube 130 and extinguishing the pilot flame.

The upper pilot shield 150 includes a horizontal member 152 and an upstanding vertical member 154 for inhibiting by-products or combustibles, particularly from the lower burners, as well as drafts, from interfering with the pilot tube 130, while allowing the entrance of secondary air (i.e., oxygen) to support the pilot flame. In the illustrated embodiment, the shield 150 of the lower pilot assembly 129 does not wrap around the pilot tube 130 (i.e., does not include a horizontal member 152 and an upstanding vertical member 154). By-product interference is not as much of a problem with the lower pilot tube 130 as with the upper pilot tube 130 and, therefore, may not require the shield 150 to wrap around the lower pilot tube 130. Alternatively, the shield 150 of the lower pilot assembly 129 can wrap around the lower pilot tube 130 in a manner similar to the shield 150 of the upper pilot assembly 128 (i.e., can include a horizontal member 152 and an upstanding vertical member 154). The upper and lower shields 150 also block radiation from the adjacent burners to increase the life of the pilot tube 130. Pilot shields 150 also include an opening 156 through which a gas line passes to supply gas to the pilot tube 130 and an opening 158 for the electronic ignition assembly 163, which will be described below.

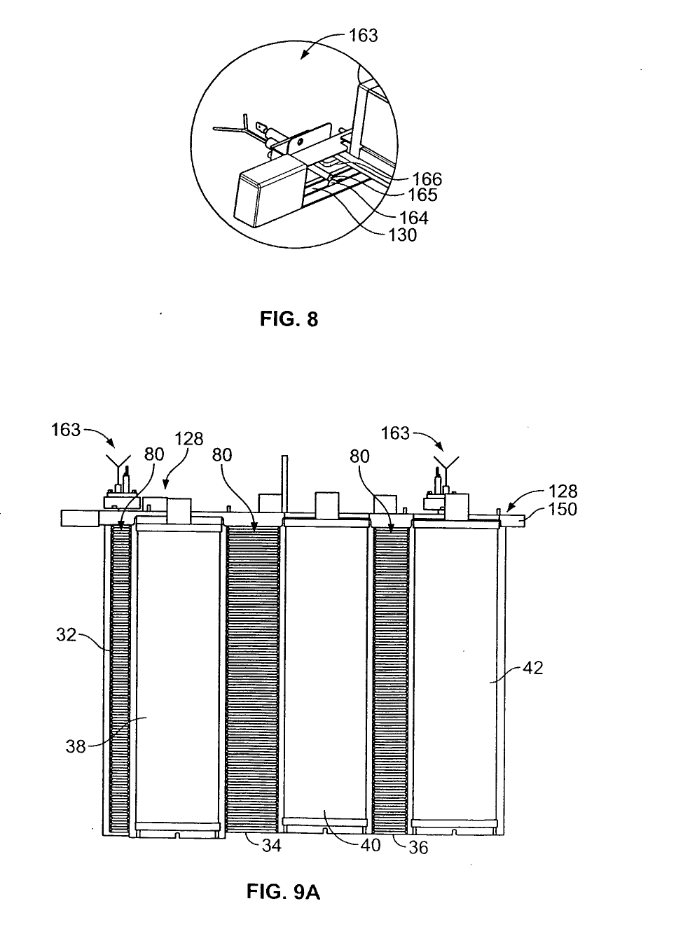

The ignition assemblies 163 of the pilot assemblies 128, 129 are shown in the enlarged view of FIG. 8. Each ignition assembly 163 includes a hot surface ignition element 165, a flame sensor 164 and a baffle 166. As noted below, among other things, the air shield 150 stops air from flowing down the pilot tube 130 and extinguishing the pilot flame. The hot surface ignition element 165 glows when it is supplied with electric current, thereby igniting the gas in the pilot tube 130. The flame sensor 164 completes a safety circuit when there is flame in the pilot tube 130 across the sensor 164.

In the illustrated embodiment, a single pilot assembly, and therefore a single pilot flame, is used to light each bank of burners (one assembly 128 for upper and one assembly 129 for lower). A single flame sensor 164 is used to sense the pilot flame in each bank of burners. This overcomes the difficulty of independently lighting each of the burners in the bank of burners and then using multiple flame sensors for sensing a flame in each of the burners. As noted earlier, the flame falls back into the ceramic burner once the burners are up and running and cannot be easily sensed. The position of the flame sensor 164 enables the pilot flame to be more easily sensed.

The use of hot surface ignition is particularly advantageous. However, other types of ignitions can be used, such as, for example electric spark, standing pilot ignition, piezo spark, etc. A spark lighting system is far less preferred, due to the necessary proximity of the sparker to the metal of the tube, which causes arcing that can miss the gas. Finally, baffle 166 minimizes the flame wave on the pilot tube 130 to insure more reliable flame sensing.

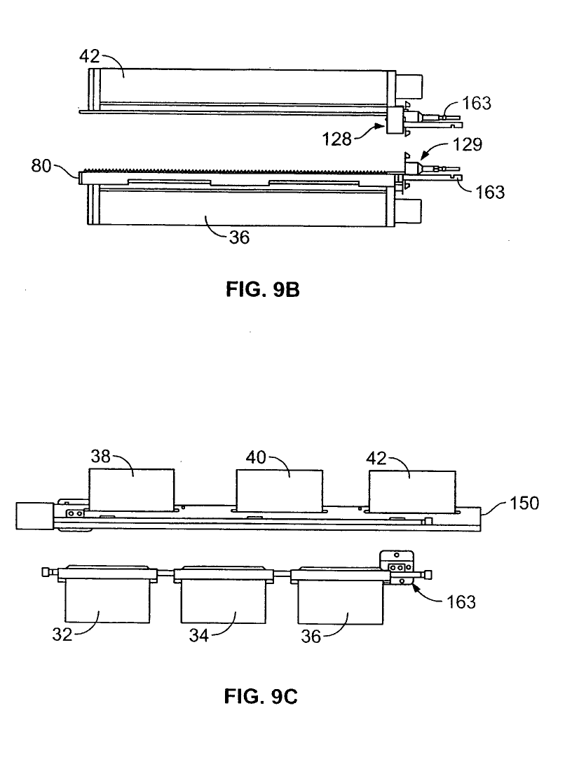

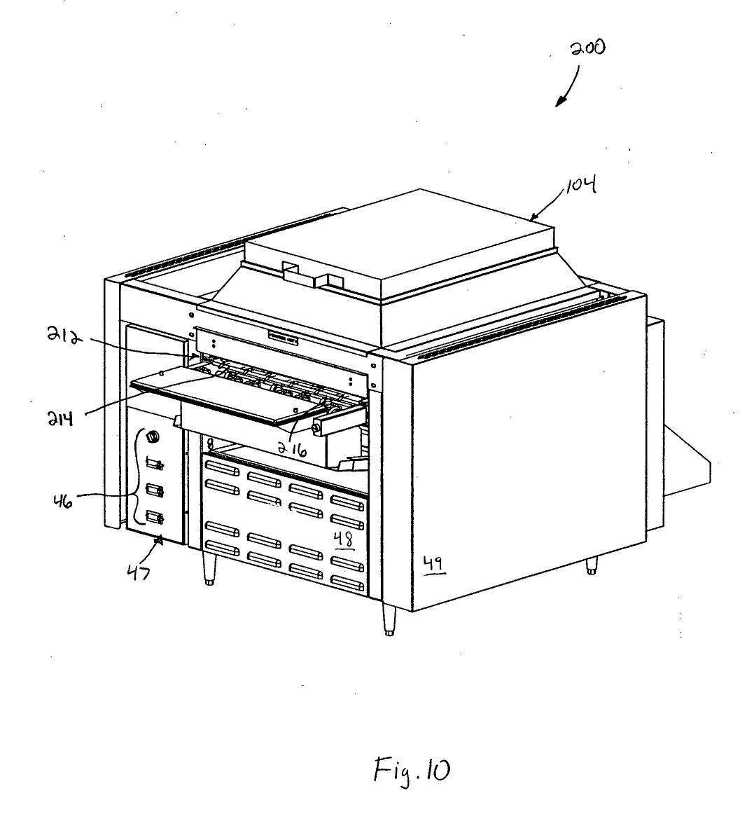

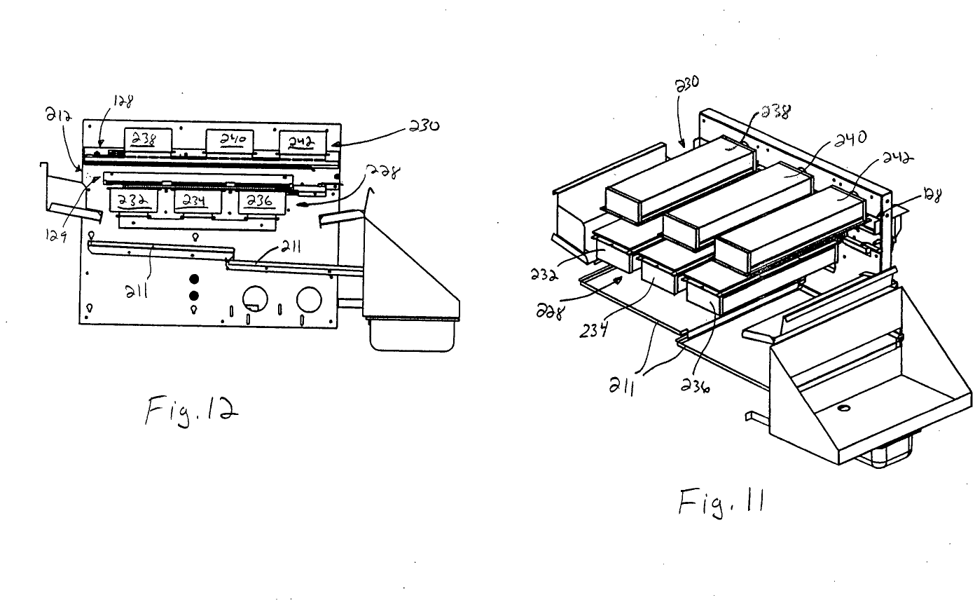

With reference to FIGS. 2, 9A, 9B and 9C, the upper and lower banks of burners 31, 33 are illustrated mounted in the charbroiler 10 to be ignited/fired up as described earlier. FIG. 9C in particular shows the offset positioning of the top burners 38, 40, 42 with respect to the bottom burners 32, 34, 36. Alternatively, the top burners 38, 40, 42 can be positioned substantially above the bottom burners 32, 34, 36. FIG. 9A shows the top burners mounted to the upper pilot assembly 128, FIG. 9B shows the spacing between the top and bottom banks of burners (e.g. about 4 inches although other spacings can be used depending on the food traveling through the charbroiler and the level of heat produced by the burner), and all of the figures contain views of upper and lower ignition systems 163.

The operation of the charbroiler may proceed as described below.

1. The charbroiler 10 is installed and provided with electricity and gas.

2. Switch 50 is turned from the “off” position to the “on” position. This starts the conveyor motors 17 and starts up the control/displays 52 and 54. Turning the switch “on” also initiates the ignition sequence.

3. The ignition sequence proceeds by energizing first and second ignition assemblies 163 associated respectively with the upper and lower banks of burners 31, 33. These ignition assemblies 163 are keyed together, with the first and second ignition assemblies 163 being energized simultaneously. Energizing the ignition assemblies 163 powers the hot surface ignition elements 165, which glow red-hot. Alternatively, the first and second ignition assemblies 163 can be energized separately (e.g., the first ignition assembly 163 can be energized first and the second ignition assembly 163 can be energized second).

4. When the ignition assemblies 163 are energized and their hot surface ignition elements are properly heated, the gas valves open and gas flows into the upper and lower pilot tubes 130. This gas is ignited by the hot surface ignition elements 165 and a pilot flame is maintained in the tubes 130.

5. When the flame sensors 164 in both the upper and lower pilot assemblies sense the flame, a signal is generated to open the main gas valve. This causes gas to flow to all of the burners. The gas at the burners is ignited by the pilot flame in the pilot tubes 130.

6. In the unlikely event that a flame in the pilot tube is lost, the flame sensors 164 is unable to sense a flame and the gas supply to the pilot tubes and the burners shuts down. The system retries the ignition sequence three times and if proper ignition is not achieved by the third try, the system requires the on/off switch 50 to be turned “off” and “on” to reset the system and begin from step 3 again.

7. Once the burners are lit and operating, the user waits until the charbroiler 10 comes up to temperature, which will typically be about 5-10 minutes.

8. Food is then placed on conveyors 14 and 16 and their speed is adjusted as desired, by control/displays 52 and 54.

9. The food enters the charbroilers through inlet opening 12 and advances through to outlet opening 110 where it is either removed by the operator or falls onto shelf 111 or a container (not shown) supplied on the shelf.

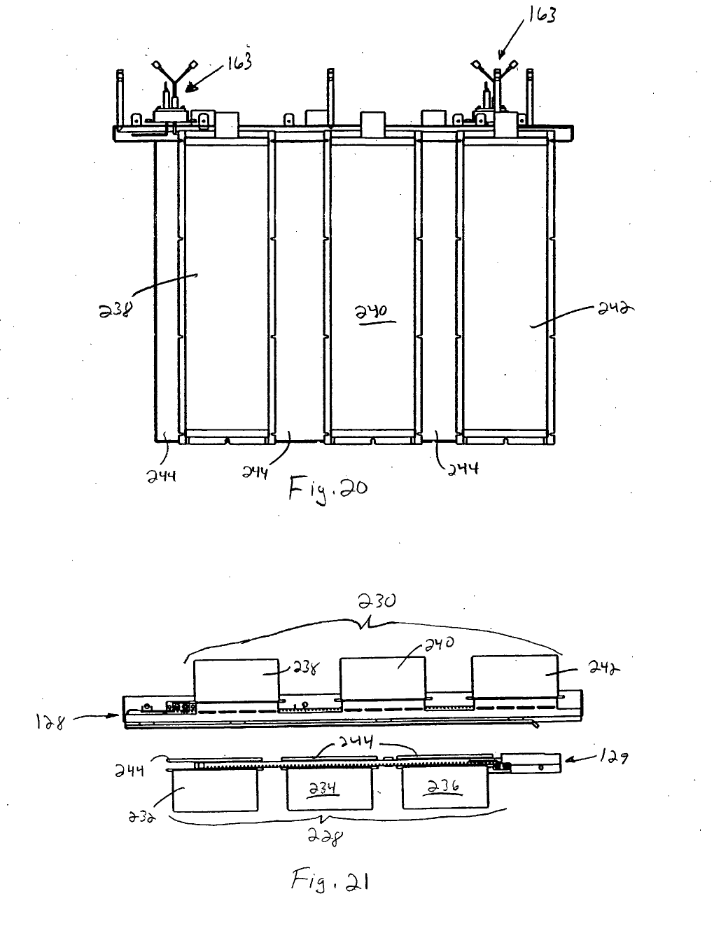

Turning now to FIGS. 10-25, an alternate embodiment of the present invention is illustrated comprising a charbroiler 200. Features described and illustrated with respect to this embodiment are capable of being employed in the charbroiler 10 of the first embodiment and vice versa, unless otherwise indicated herein or otherwise clearly contradicted by context. As in the case of charbroiler 10, this charbroiler also includes a series of upper and lower burners and a pair of conveyors for transporting food through the charbroiler between the upper and lower burners. Thus, charbroiler 200 includes an inlet opening 212 in which conveyors 214, 216 are shown (although any number of conveyors may be used). Conveyors 214, 216 extend beyond opening 212 to enable meat or other food items to be placed onto the conveyor(s) before it/they move the food into and through the charbroiler 200. The conveyors are of an open metal grid design to permit heat from the lower burners to reach the bottom of the food supported on the belt and to permit juices, fats and other food components to drip through the belt during the cooking process. These juices are collected in a tray 211 positioned below the lower burners from which the collected juices drip (see FIGS. 11 and 12).

Additionally, with reference to FIGS. 10 and 13, it is noted that in this embodiment of the invention, a quick-disconnect conveyor structure 217 is provided. The quick-disconnect conveyor structure 217 includes a number of removable securing pins 218 (e.g., four in the illustrated embodiment) engageable with a conveyor frame 219 and interior side walls of the charbroiler 200 to secure the conveyor frame 219 and the conveyors within the charbroiler 200.

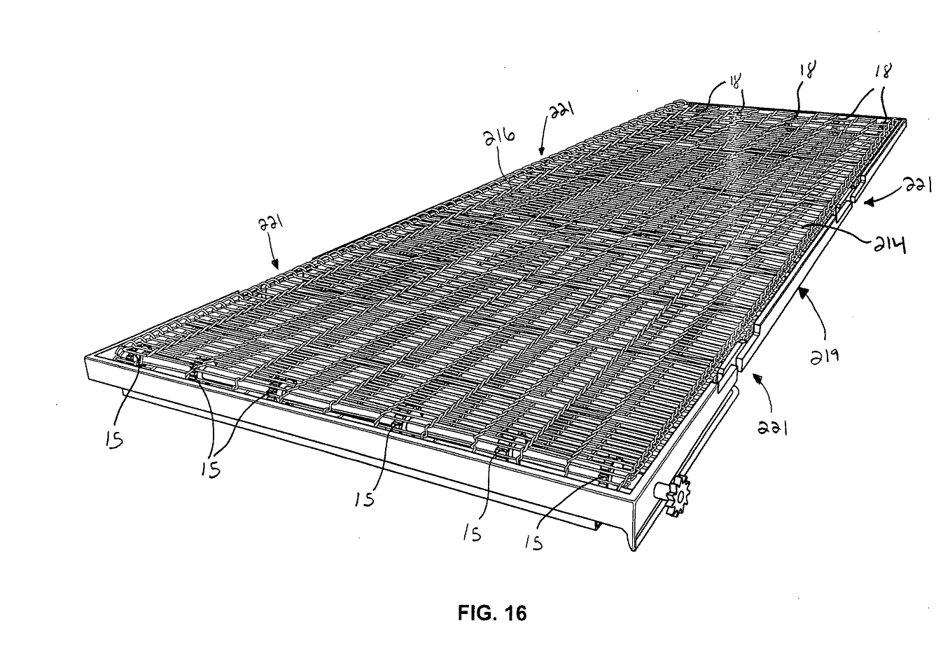

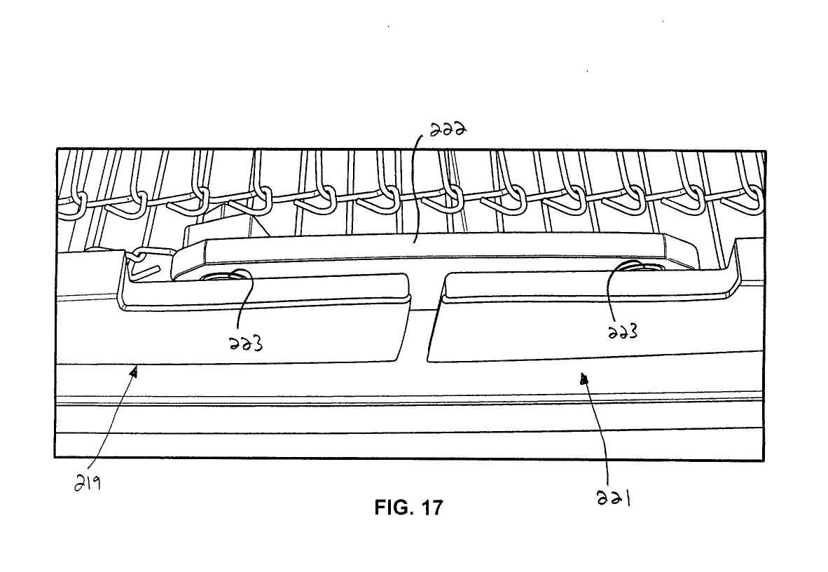

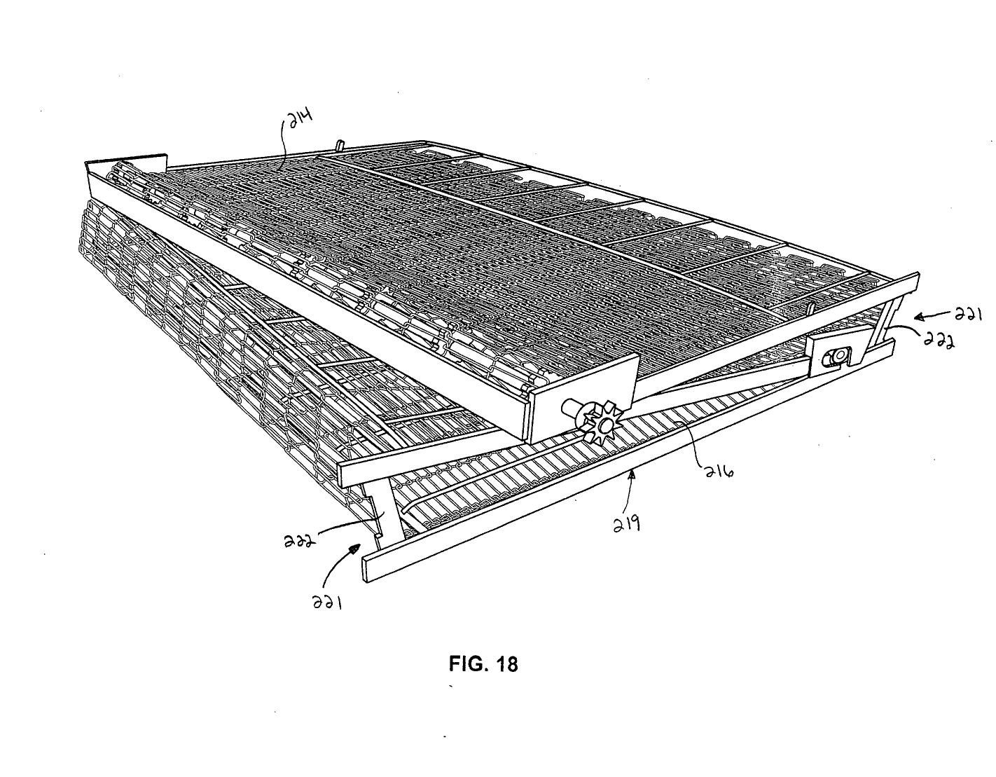

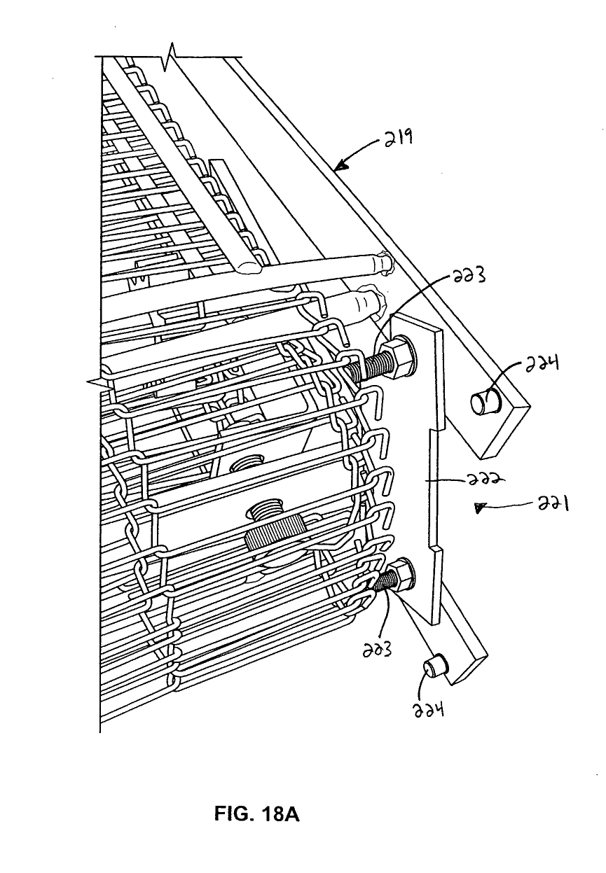

With reference to FIGS. 16-18A, the conveyor frame 219 can be foldable when removed from the charbroiler 200. The conveyor frame 219 can be folded with the conveyor belts 214, 216 connected thereto or disconnected therefrom. In the figures, the conveyor frame 219 is shown in the folded condition with the conveyor belts 214, 216 connected thereto. The conveyor frame 219 is made of a plurality of sections, which are connected by a plurality of pivot links 221. The pivot links 221 allow the conveyor frame 219 to move between the folded condition (see FIGS. 18 and 18A) and an unfolded condition (see FIGS. 16 and 17). In the illustrated embodiment, the conveyor frame 219 includes three sections and four pivot links 221, which allow the conveyor frame 219 to trifold. Alternatively, the conveyor frame 219 can include any number of sections and pivot links and can be folded any number of times (i.e., bifold, quadrafold, etc.). With particular reference to FIG. 17, each pivot link 221 includes a body member 222 and a pair of pivot rods 223, which are pivotally connected between the conveyor frame 219 and ends of the body member 222. When in the unfolded condition, ends of the body members 222 engage projections 224 of the conveyor frame 219 to limit movement and maintain the pivot links 221 in the unfolded condition.

Removal and folding of the conveyor frame 219 and conveyor belts 214, 216 will now be described with reference to FIGS. 10 and 13-18A. Conveyors 214, 216 may require frequent cleaning due to the build-up of greases and other food product thereon. The conveyor frame 219 and conveyor belts 214, 216 are easily removable to facilitate cleaning thereof. In the illustrated embodiment, chains 220 are interconnected between the motors 17 and the drive sprockets 15. To remove the conveyor frame 219 and conveyor belts 214, 216 for cleaning, the chains 220 must be first removed from between the motors 17 and drive sprockets 15, and the securing pins 218 must be removed from engagement with the conveyor frame 219 and the interior walls of the charbroiler 200. The securing pins 218 are rotated from a locked position to an unlocked position and pulled outwardly away from the charbroiler 200. Once the securing pins 218 and chains 220 are removed, the conveyor frame 219 and conveyor belts 214, 216 can be removed from the inlet or outlet openings of the charbroiler. As discussed above, the conveyor belts 214, 216 can either be removed from or remain connected to the conveyor frame 219 for cleaning. The conveyor frame 219 is then folded via pivot links 221 to facilitate easier cleaning thereof by, for example, placement of the conveyors into a dishwasher.

The positioning of the conveyor belts vis-à-vis the top and bottom burners, as well as the controls for the charbroiler are generally as described in connection with charbroiler 10.

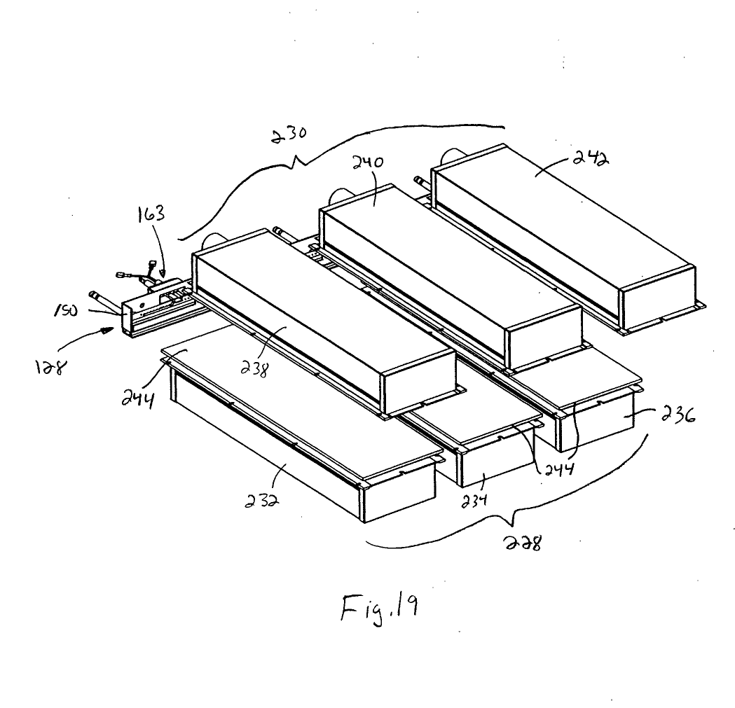

With reference to FIGS. 19-22D, the burners of the charbroiler 200 are shown. Charbroiler 200 includes generally similar burners and a similar burner configuration as charbroiler 10. Charbroiler 200 includes a generally horizontal lower bank 228 of burners 232, 234 and 236, and a generally horizontal upper bank 230 of burners 238, 240 and 242. Of course, any desired number of upper and lower burners may be used. The upper and lower banks of burners are arranged generally parallel to each other with the heating surfaces of each bank of burners oriented opposite each other.

However, unlike charbroiler 10, charbroiler 200 does not include screens 80, but includes a different type of shielding member disposed between the burners and the food product. With reference to FIGS. 19, 23A-23D, 25 and 26, a series of generally rectangular plates 244 with top surfaces 246 and bottom surfaces 248 corresponding generally in length and width to the length and width of screens 80 are provided in lieu of the screens. The plates 244 can be made of solid glass or glass/ceramic combination and can include a coating, which will be described in greater detail below. Plates made of these types of materials are much cooler than metal, which is usually the material used to manufacture burners, and reduce the chance of flare-up as compared to flare-up occurring when grease contacts the metal burners. The plates 244 are positioned in broiler 200 similarly to the positioning of screens 80 in broiler 10. Thus the heating surfaces of the burners are covered by the plates 244, thereby protecting the burners from grease and other debris falling from or dripping from the food product being carried along through the charbroiler on the conveyor belts. These plates enhance the infrared effect produced by the burners by substantially improving the distribution of the infrared heat. The plates further help disperse the combustibles emerging from the lower burners which have the potential to interfere with the operation of the upper burners by reducing the oxygen available for combustion. As a result, the upper burners tend to run more efficiently than would otherwise be the case and may be positioned more closely together, producing greater heating and accelerated broiling.

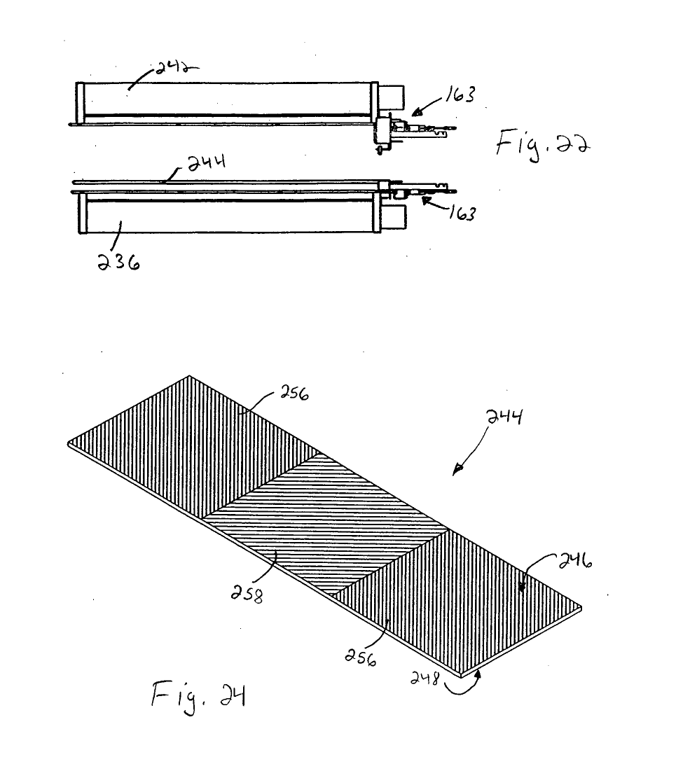

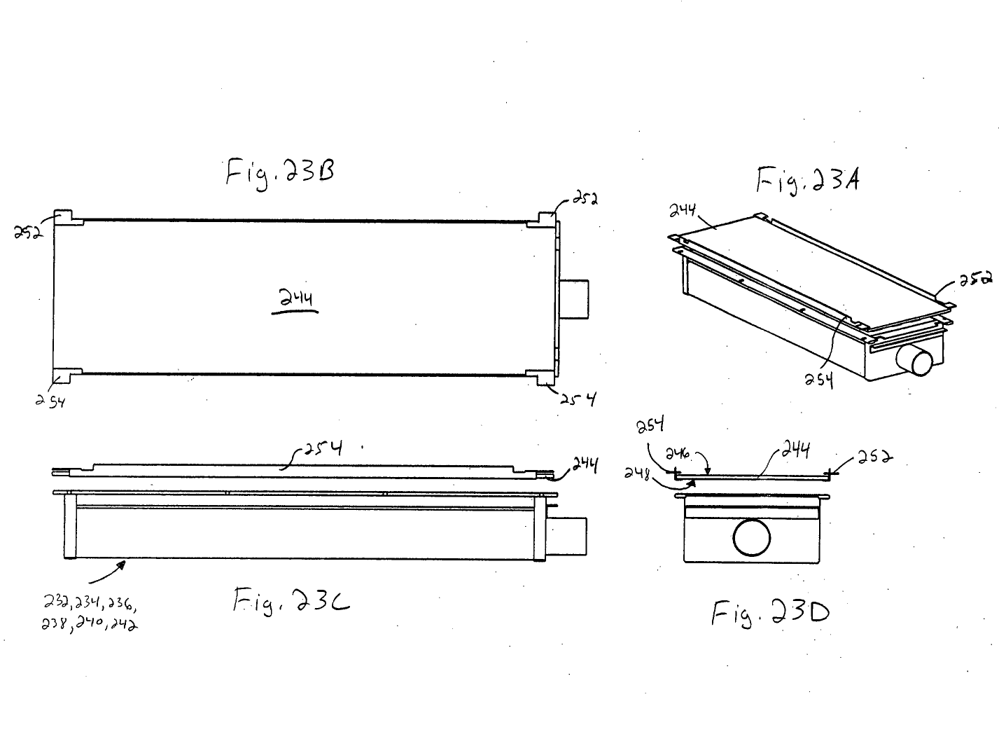

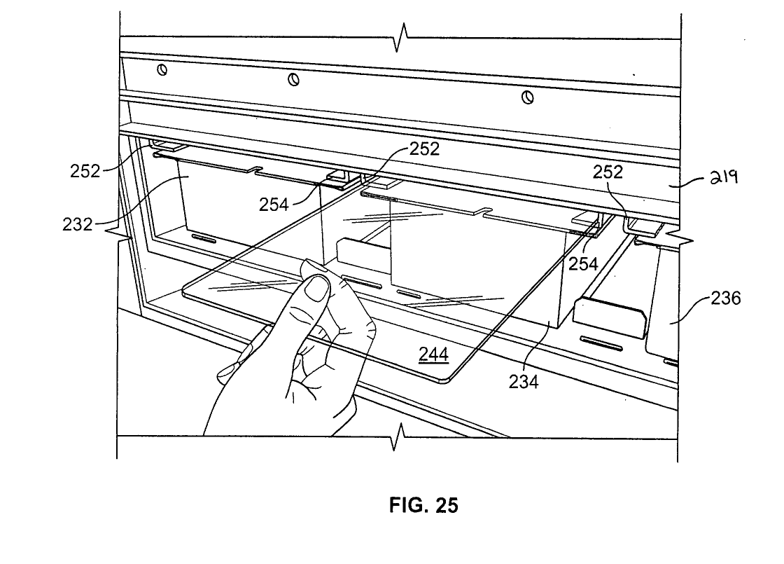

With reference to FIGS. 23A-23D and 25, the plates 244 are held in place by pairs of brackets 252 and 254 into which the plates are slid before operation of the charbroiler is commenced. These brackets are made as narrow as practically possible to minimize metal-to-plate contact (other mounting structures may of course be used). In the illustrated embodiment, the brackets 252, 254 are mounted to the conveyor frame 219 of the charbroiler 200. In other embodiments, the brackets 252, 254 are mounted to the housing of the charbroiler or the burners. Plates 244 can be left in place indefinitely, relying on the heat of the burners to burn off any grease or debris that falls onto the plates. Alternatively, if desired, the plates can be permitted to cool when the charbroiler is turned off, slid out of their normal position, and either scraped or washed by hand or placed in a dishwasher for cleaning.

It is preferred that the plates be spaced from the heating surfaces of the burners not less than about 0.125 inches (about 3.175 millimeters) to ensure that enough secondary air reaches the burners. Preferably the plates will be spaced from the heating surfaces of the burners a distance in the range of about 0.125 to 3.00 inches (about 3.175 to 76.20 millimeters), and most preferably at about 1.25 inches (31.75 millimeters).

It is generally required that the plates 244 be able to withstand the heat produced by the burners with minimal thermal expansion and distortion. Highly desirable materials that may be used to construct plates 244 are available from Schott Home Tech of Louisville, Ky. These materials include CERAN HIGHTRANS® and ROBAX® glass ceramic cooktop panel material. CERAN HIGHTRANS glass ceramic comprises a translucent glass ceramic dyed in the batch. It may come in any desired color. The top surface of this translucent glass ceramic is generally smooth whereas the bottom surface is textured. Plates 244 may be made from this material in any desirable thickness. Preferably, the plates should be about 4.0 millimeters thick. More preferably, the plates have a thickness between about 4 millimeters and about 2 millimeters. Most preferably, the plates have about a 2 millimeter thickness.

This material has the following thermal properties:

Coefficient of Mean Linear Thermal Expansion

| | |
|---|---|
| α (20-700° C.): | 0 ± 0.15 × 10⁻⁶K⁻¹ |
| α (68-1292° F.): | 0 ± 0.83 × 10⁻⁷F⁻¹ |

Mean Specific Thermal Capacity

| | |
|---|---|
| (20-100° C.) | approx. 0.8 Jg⁻¹K⁻¹ |
| (68-212° F.) | approx. 0.191 BTU/lb ° F. |

Thermal Conductivity

| | |
|---|---|
| λ (100° C.) | approx. 1.6 W/mK |
| λ (212° F.) | approx. 0.077 BTU/lb hr ° F. |

CERAN HIGHTRANS glass ceramic is generally resistant to cracking due to thermal stress T_{upper max}¹⁾≦700° C. (1292° F.). The temperature/time-load capacity of the material, with the following temperatures referring to the upper side of the plate, is as follows:

| Load Temperature T_{upper max} | Time-load | |
|---|---|---|
| 560° C. (1040° F.) | 5000 | h |
| 610° C. (1130° F.) | 1000 | h |
| 660° C. (1220° F.) | 100 | h |
| 710° C. (1310° F.) | 10 | h |

Finally, the optical properties are as follows:

Transmission

| | | |
|---|---|---|
| 600 | nm | 1.5-3.5% |
| 700 | nm | 15-22% |
| 1600 | nm | ≧70% |

ROBAX glass ceramic is a highly transparent glass ceramic with a nearly zero thermal expansion and substantial mechanical resistance provided in flat, rolled sheets. Because of its low thermal expansion, this material can be subjected to extreme temperature differences and will maintain excellent stability of form. The thermal properties of this product are as follows:

### Linear Thermal Coefficient of Expansion

α_{(20-700° C.)}=(0.0±0.3)×10⁻⁶° K⁻¹

### Thermal Conductivity at 90° C. (194° F.)

k=1.6 W/(m° K)

### Mean Specific Heat Capacity

_{Cp(20-100° C.)}=0.8 J/g° K

With reference to FIGS. 19, 23A-23D and 24, the plates 244 may be made from any appropriate glass and/or ceramic material and can be coated with a ceramic material 256. The coating 256 can be fused onto any portion of the plate 244 and in any configuration on the plate 244. For example, the surface of the plate 244 may be coated in a grid-like pattern of open and coated areas, in alternating strips of coating 256 and open areas, in a series of ceramic dots, in a continuous fashion over the entire surface of the plate, etc. Examples of coatings that can be used with the plates 244 are CERAN-HIGHTRANS manufactured by Schott North America, Inc. and PYROCERAM III glass-ceramic manufactured by Eurokera Glass, Inc.

The plates 244 may also be coated with more than one type of coating (see FIG. 24). Various types of coatings, having various thermal properties, can be applied to the plates 244 to affect the heat attenuation properties of the plates 244. The various types of coatings are often color coordinated to distinguish and identify the type of coating and the thermal properties of the plates 244. For example, the colors chosen can be coordinated with the amount of heat attenuation produced by a particular plate (based on thickness of plate or coating, percentage of surface coated, etc.) so that an operator can run a burner at full heat (and typically greatest burning efficiency) but attenuate the heat reaching the food as desired by choosing an appropriately colored plate. As illustrated in FIG. 24, the plate 244 includes a first coating 256 near the ends of the plate 244 and a second coating 258 in the middle of the plate. Finally, the coloring of the plates 244 have an aesthetic appeal which may lead to more ready customer acceptance.

The variety of coatings and the variety of patterns in which the plates 244 can be coated provides a large number of permutations for controlling the heat attenuation of the burners and, therefore, the manner in which food is cooked. The cooking flexibility and options increase even further by introducing burners having varying BTU rates or heating capacities into the charbroiler. A charbroiler where the coatings of the plates 244 and the capacity of the burners can be widely varied, as in the present invention, to accommodate different cooking environments and parameters has great flexibility in controlling the cooking operations thereof. For example, when cooking a steak, the charbroiler 200 can include a burner and a plate coating facilitating high heat attenuation at the beginning of the cooking process to initially cook the food product quickly. Near the end of the cooking operation, the charbroiler 200 can include a burner and a plate coating that facilitate low heat attenuation to cook the food product slowly near the end of the cooking operation. In such an example, the first and/or second of the upper and lower burners may have a high BTU rate and the coatings on their respective plates 244 could allow high heat attenuation. The last of the upper and lower burner(s) may have a low BTU rate and the coatings on their respective plates 244 could allow low heat attenuation.

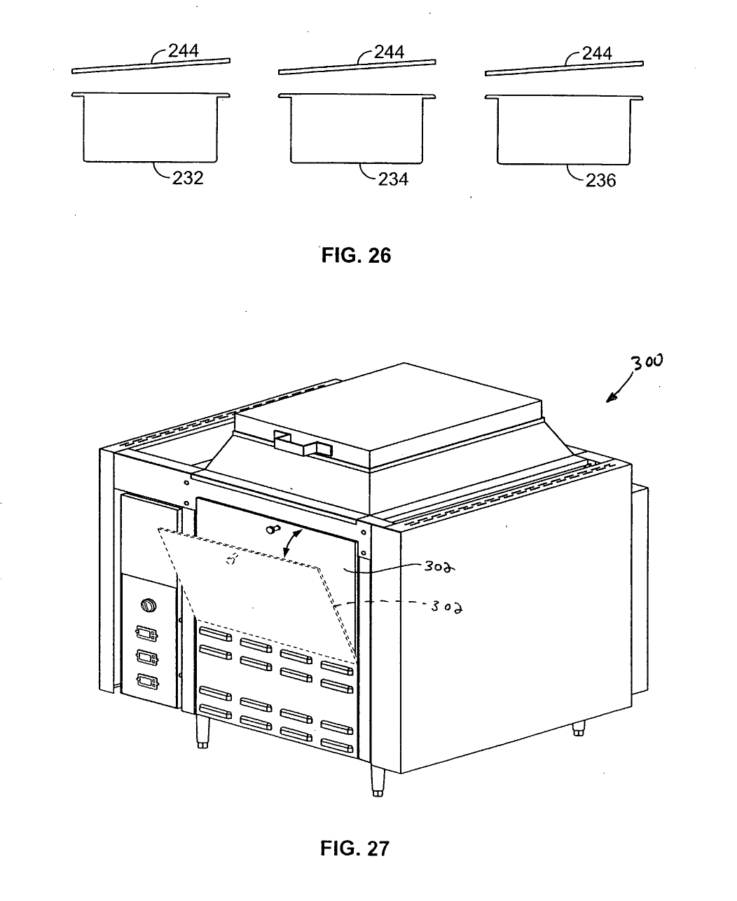

With reference to FIG. 26, the plates 244 are angled relative to the burners to cause grease and other by-products from the food being cooked to run-off of the plates and into the drip tray 211, where the grease and other food products accumulate for later disposal. Flare-up is further inhibited by the angled plates. Such angling prevents accumulation of grease and other products on the plates which may combust over a period of time. In the illustrated embodiment, the plates are substantially all positioned at the same angle. Alternatively, the plates may be angled differently with respect to each other and in more than one direction (i.e., angles both downward and toward a side of the charbroiler).

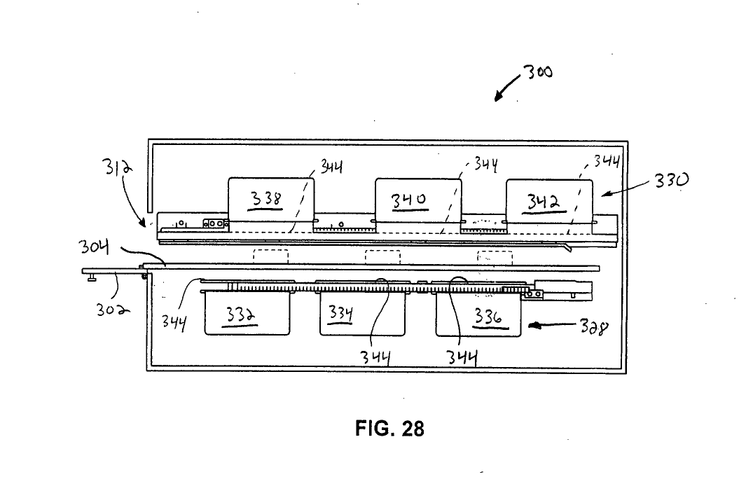

Referring now to FIGS. 27 and 28, a batch charbroiler 300 is illustrated. The batch charbroiler includes both upper and lower banks of burners 330, 328 and includes plates 344 disposed above the lower bank of burners 328 and below the upper bank of burners 330. The batch charbroiler 300 includes a housing having walls that define a food cavity and a door 302 positioned over opening 312 to selectively open and close the food cavity within the batch charbroiler 300. A moveable grilling surface 304 is supported by the housing and is moveable into and out of the food cavity through the opening 312. Food is positionable on the moveable grilling surface 304 so that it can be moved into and out of the food cavity by the grilling surface 304.

The plates 344 inhibit flare-up in the batch charbroiler 300 and divert by-products produced by the lower bank of burners 328 from rising directly toward the upper bank of burners 330 and thereby interfering with operation and efficiency of the upper bank of burners 330. Alternatively, one plate 344 can be used to cover more than one burner 328 in the lower bank or a single plate 344 can be used to cover all of the burners 328 of the lower bank. Whether a single plate 344 or more than one plate 344 is used, the plate(s) can be tilted (see, e.g., FIG. 26) to allow grease and cooking debris to run off to a grease drawer. Additionally, the angled bottom of the glass or ceramic plate can be used to direct the by-products of combustion out of the unit to a flare stack. Without the plates 344, grease and other food product would fall into the lower burners 332, 334, 336 and cause flare-ups, which would cook the food to an undesired extent. Also, without the plates 344, by-products from the lower burners 332, 334, 336 would rise directly upward toward the upper burners 338, 340, 342 displacing much needed oxygen around the upper burners 338, 340, 342 and decreasing the efficiency of the upper burners 338, 340, 342. Accordingly, a batch charbroiler can be provided with a lower bank of burners as well as an upper bank of burners if plates are positioned over the lower burners, thereby eliminating the need to flip the food in order to cook both sides of the food as was previously required in other batch charbroilers having only an upper bank of burners.

Various embodiments of this invention are described herein. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A charbroiler comprising:
a housing;
a plurality of burners positioned within the housing for heating food product positioned within the housing;
a gas line coupled to the plurality of burners for providing gas to the burners; and
a single pilot flame receiving gas from the gas line and being operable to ignite the plurality of burners.

2. The charbroiler of claim 1 further comprising a single ignition system for igniting the pilot flame.

3. The charbroiler of claim 1 wherein the gas line is the only gas line for providing gas to the burners.

4. The charbroiler of claim 1 further comprising a pilot flame distributor in fluid communication with the gas line and the plurality of burners, the pilot flame distributor receiving gas from the gas line, wherein the pilot flame from the pilot flame distributor ignites the plurality of burners.

5. The charbroiler of claim 4, wherein the pilot flame distributor is an elongated tube extending along the plurality of burners.

6. The charbroiler of claim 4, further comprising an air shield at least partially surrounding the pilot flame distributor to inhibit air from extinguishing the pilot flame.

7. The charbroiler of claim 1 further comprising a single ignition system for igniting the pilot flame, wherein the single ignition system includes a hot surface ignition element for igniting the pilot flame.

8. The charbroiler of claim 7 wherein the ignition system includes a flame sensor for sensing the presence of the pilot flame and a baffle for controlling the pilot flame.

9. The charbroiler of claim 1 wherein the charbroiler is a conveyorized charbroiler, the conveyorized charbroiler further comprising a conveyor positioned to move food product through the housing.

10. The charbroiler of claim 1 wherein the charbroiler is a batch charbroiler, and wherein the housing defines a cavity with an opening through which food product is insertable into and removable from the cavity.

11. A conveyorized charbroiler comprising:
a housing defining a heated tunnel therethrough;
a conveyor at least partially positioned within the housing to move food product through the tunnel, wherein the conveyor is removable from the housing; and
a burner positioned within the housing for heating food product moving through the tunnel.

12. The conveyorized charbroiler of claim 11 further comprising at least one securing pin removably engageable with the housing and the conveyor to removably secure the conveyor within the housing.

13. The conveyorized charbroiler of claim 11 further comprising four securing pins removably engageable with the housing and the conveyor to removably secure the conveyor within the housing.

14. The conveyorized charbroiler of claim 11 wherein the conveyor is foldable.

15. The conveyorized charbroiler of claim 11 wherein the conveyor includes a conveyor frame and a conveyor belt connected to the conveyor frame, wherein the conveyor frame and conveyor belt are removable from the housing.

16. The conveyorized charbroiler of claim 15 wherein the conveyor belt is removable from the conveyor frame.

17. A conveyorized charbroiler comprising:
a housing defining a heated tunnel therethrough;
a conveyor at least partially positioned within the housing to move food product through the tunnel;
a burner positioned within the housing for heating food product positioned within the tunnel; and
a shielding member connected to one of the housing and the burner in a position between the burner and food product, the shielding member being at least partially made of glass.

18. The conveyorized charbroiler of claim 17 wherein the shielding member is removably connectable to the one of the housing and the burner.

19. The conveyorized charbroiler of claim 18 wherein the shielding member is slidably removable from the one of the housing and the burner.

20. The conveyorized charbroiler of claim 17 wherein the shielding member is connected to the conveyor.

21. The conveyorized charbroiler of claim 20 wherein the conveyor includes a flange and an edge of the shielding member is supported by the flange to connect the shielding member to the conveyor.

22. The conveyorized charbroiler of claim 17 wherein the shielding member is spaced between about 0.125 to 3.00 inches from a top surface of the burner.

23. The conveyorized charbroiler of claim 17 wherein the shielding member is spaced about 1.25 inches from a top surface of the burner.

24. The conveyorized charbroiler of claim 17 wherein the shielding member is made of glass or ceramic.

25. The conveyorized charbroiler of claim 17 wherein the shielding member is a plate.

26. A batch charbroiler comprising:
a housing defining a food cavity therein with an opening through which food is insertable into and removable from the food cavity;
a burner positioned within the housing for heating food product positioned within the food cavity; and
a shielding member connected to one of the housing and the burner in a position between the food product and the burner, the shielding member being at least partially made of glass.

27. The batch charbroiler of claim 26 wherein the shielding member is removably connectable to the one of the housing and the burner.

28. The batch charbroiler of claim 27 wherein the shielding member is slidably removable from the one of the housing and the burner.

29. The batch charbroiler of claim 26 wherein the shielding member is connected to the housing.

30. The batch charbroiler of claim 29 wherein the housing includes a flange and an edge of the shielding member is supported by the flange to connect the shielding member to the housing.

31. The batch charbroiler of claim 26 wherein the shielding member is made of glass or ceramic.

32. A charbroiler comprising:
a housing defining a cavity with an opening through which food product is insertable into the cavity;
a burner positioned within the housing for heating food product positioned within the cavity; and
a shielding member connected to one of the housing and the burner in a position between the food product and the burner, the shielding member being at least partially coated with a ceramic material.

33. The charbroiler of claim 32 wherein the charbroiler is a conveyorized charbroiler and includes a conveyor at least partially positioned within the housing to move food product through the cavity.

34. The charbroiler of claim 32 wherein the charbroiler is a batch charbroiler and the food product is removable out of the cavity through the opening.

35. The charbroiler of claim 32 wherein the shielding member is removable from one of the housing and the burner.

36. The charbroiler of claim 32 wherein the shielding member is at least partially glass or ceramic.

37. The charbroiler of claim 32 wherein the ceramic material coats the surface of the shielding member in a grid like pattern.

38. The charbroiler of claim 32 wherein the ceramic coating coats the surface of the shielding member in a series of ceramic dots.

39. The charbroiler of claim 32 wherein the ceramic material has a color associated with a property of at least one of the shielding member and the coating.

40. The charbroiler of claim 32 wherein the ceramic material is a first ceramic material, and further comprising a second ceramic material at least partially coating the shielding member, the first and second ceramic materials being different.

41. A conveyorized charbroiler comprising:
a housing defining a heated tunnel therethrough;
a conveyor at least partially positioned within the housing to move food product through the tunnel; and
a burner positioned within the housing for heating food product moving through the tunnel, the burner including a ceramic diaphragm capable of emitting heat.

42. The conveyorized charbroiler of claim 41 wherein the burner is positioned below the conveyor and the food product.

43. The conveyorized charbroiler of claim 41 wherein the burner is positioned above the conveyor and the food product.

44. The conveyorized charbroiler of claim 41 further comprising a shielding member connected to one of the housing and the burner and positioned between the burner and the food product.

45. The conveyorized charbroiler of claim 44 wherein the shielding member is at least partially coated with a ceramic material.

46. A charbroiler for cooking food product, the charbroiler comprising:
a housing;
an upper burner positioned within the housing and above the food product for heating the food product, the upper burner including a ceramic diaphragm capable of emitting heat; and
a lower burner positioned within the housing and below the food product for heating the food product, the lower burner including a ceramic diaphragm capable of emitting heat.

47. The charbroiler of claim 46 wherein the charbroiler is a conveyorized charbroiler and includes a conveyor at least partially positioned within the housing to move food product through the housing.

48. The charbroiler of claim 46 wherein the charbroiler is a batch charbroiler.

49. The charbroiler of claim 46 further comprising an upper shielding member positioned between the upper burner and the food product and a lower shielding member positioned between the lower burner and the food product.

50. The charbroiler of claim 49 wherein the upper and lower shielding members are at least partially coated with a ceramic material.

51. A charbroiler for cooking food product, the charbroiler comprising:
a housing in which food product is positionable for cooking;
a first burner positioned within the housing for cooking food product; and
a second burner positioned within the housing for cooking food product;
wherein the first burner and the second burner have different heating capacities.

52. The charbroiler of claim 51 wherein the different heating capacities of the first and second burners are measured as BTU rates.

53. The charbroiler of claim 51 wherein the charbroiler is a conveyorized charbroiler and includes a conveyor at least partially positioned within the housing to move food product through the housing.

54. The charbroiler of claim 51 wherein the charbroiler is a batch charbroiler.

55. The charbroiler of claim 51 further comprising a first shielding member positioned between the first burner and the food product and a second shielding member positioned between the second burner and the food product.

56. A charbroiler comprising:
a housing in which food product is positionable for cooking;
a burner positioned within the housing for cooking the food product in the housing; and
a shielding member connected to one of the housing and the burner in a position between the food product and the burner, the shielding member being at least partially coated with a material having a color relating to a property of at least one of the material and the shielding member.

57. The charbroiler of claim 56 wherein the material is at least partially ceramic.

58. The charbroiler of claim 56 wherein the color of the material relates to a property of the material.

59. The charbroiler of claim 58 wherein the color of the material relates to a property of the shielding member.

60. The charbroiler of claim 56 wherein the charbroiler is a conveyorized charbroiler and includes a conveyor at least partially positioned within the housing to move food product through the housing.

61. The charbroiler of claim 56 wherein the charbroiler is a batch charbroiler.
